(19) United States
(12) Patent Application Publication
(10) Pub. No.: US 2016/0328314 A1
(43) Pub. Date: Nov. 10, 2016

(54) SYSTEM AND METHOD FOR PROVIDING CODE COVERAGE

(71) Applicant: HCL Technologies Limited, Noida (IN)

(72) Inventors: Sanjay Kumar Yadava, Noida (IN); Johnson Selwyn, Chennai (IN); S U M Prasad Dhanyamraju, Hyderabad (IN); Ambica Jain, Noida (IN); Arivukarasu Sivanesan, Chennai (IN)

(21) Appl. No.: 15/079,595

(22) Filed: Mar. 24, 2016

(30) Foreign Application Priority Data
May 6, 2015 (IN) 1249/DEL/2015

(51) Int. Cl. G06F 11/36; G06F 17/27

(52) U.S. Cl. CPC G06F 11/3676; G06F 11/3688; G06F 17/272; G06F 11/3644

(57) ABSTRACT

Disclosed is a method and system for providing code coverage of a code. The system may determine a type of file comprising the code. The system may extract a source code from the code, based on the type of file. The system may process the source code for generating a structured source code. The system may determine code coverage of the structured source code by executing test cases upon the structured source code. The system may provide a code coverage report comprising line coverages, program coverages, and code block coverages of the structured source code.

### CROSS-REFERENCE TO RELATED APPLICATIONS AND PRIORITY

The present application claims benefit from Indian Complete Patent Application No. 1249/DEL/2015, filed on May 6, 2015, the entirety of which is hereby incorporated herein by reference for all purposes.

### TECHNICAL FIELD

The present subject matter described herein, in general, relates to determining code coverage of a code.

### BACKGROUND

A program code developed by programming developers is tested before installation of the program code on a client machine. The program code may be tested via manual or automatic testing methods using various test cases. The test cases are executed on the program code in different scenarios and testing environments to improve quality of a software product. Thus, for achieving a best quality of the software product, a maximum amount of the program code must be covered by the test cases. An extent of the program code covered by the test cases is identified as code coverage and is stored as code coverage reports.

The code coverage reports are used to identify non-functional code or dead code present in the program code. Conventionally, the code coverage reports are generated at a file level show aggregated code coverage for all the test cases. It becomes tedious in such cases to separately identify an exact part of the program code which is covered or is dead for each test case and a number of test cases executed on each line of the program code.

### SUMMARY

This summary is provided to introduce aspects related to systems and methods for providing code coverage of a code and the aspects are further described below in the detailed description. This summary is not intended to identify essential features of the claimed subject matter nor is it intended for use in determining or limiting the scope of the claimed subject matter.

In one implementation, a method for providing code coverage of a code is disclosed. The method may comprise determining a type of file comprising a code. The method may further comprise extracting a source code from the code based on the type of file. The source code may be extracted using a parser. The method may comprise processing the source code for generating a structured source code. The method may comprise creating code blocks indicative of a portion of the structured source code, based on a declaration of statements, functions, and sub-functions. The method may comprise determining code coverage of the structured source code by executing test cases upon the structured source code. The method may comprise providing a code coverage report comprising line coverages, program coverages, and the code block coverages of the structured source code.

In one implementation, a system for providing code coverage of a code is disclosed. The system comprises processor and a memory coupled to the processor for executing programmed instructions stored in the memory. The processor may determine a type of file comprising a code. The processor may extract a source code from the code based on the type of file. The source code may be extracted using a parser. The processor may process the source code for generating a structured source code. The processor may create code blocks indicative of a portion of the structured source code, based on a declaration of statements, functions, and sub-functions. The processor may determine code coverage of the structured source code by executing test cases upon the structured source code. The processor may provide a code coverage report comprising line coverages, program coverages, and the code block coverages of the structured source code.

In one implementation, a non-transitory computer readable medium embodying a program executable in a computing device for providing code coverage of a code is disclosed. The program may comprise a program code for determining a type of file comprising a code. The program may comprise a program code for extracting a source code from the code based on the type of file. The source code may be extracted using a parser. The program may comprise a program code for processing the source code for generating a structured source code. The program may comprise a program code for creating code blocks indicative of a portion of the structured source code, based on a declaration of statements, functions, and sub-functions. The program may comprise a program code for determining code coverage of the structured source code by executing test cases upon the structured source code. The program may comprise a program code for providing a code coverage report comprising line coverages, program coverages, and the code block coverages of the structured source code.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for providing code coverage of a code, in accordance with an embodiment of the present subject matter.

FIG. 2 illustrates code blocks corresponding to a JavaScript code, in accordance with an embodiment of the present subject matter.

FIG. 3 illustrates a flowchart showing a method for determining code block coverages.

FIG. 4 illustrates an exemplary code coverage report of code blocks corresponding to a JavaScript code, in accordance with an embodiment of the present subject matter.

FIG. 5 illustrates an exemplary code coverage report comprising program coverages i.e. coverage of functions by test cases, in accordance with an embodiment of the present subject matter.

FIG. 6 shows flowchart illustrating a method for providing code coverage of a code, in accordance with an embodiment of the present subject matter.

### DETAILED DESCRIPTION

System and method for providing code coverage of a code are described in the present subject matter. The system may determine a type of file comprising a code. The system may extract a source code from the code based on the type of file, as determined by the system. The system may extract the source code by using a parser. The system may process the source code for generating a structured source code. The system may instrument the structured source code for recording and identifying the code coverage of source code. Further, the system may generate code blocks of the structured source code. The system may determine code coverage of the structured source code by executing test cases upon the structured source code. The system may provide the code coverage report comprising line coverages, program coverages, and the code block coverages of the structured source code.

While aspects of described system and method for providing code coverage of an uncompiled code may be implemented in any number of different computing systems, environments, and/or configurations, the embodiments are described in the context of the following exemplary system.

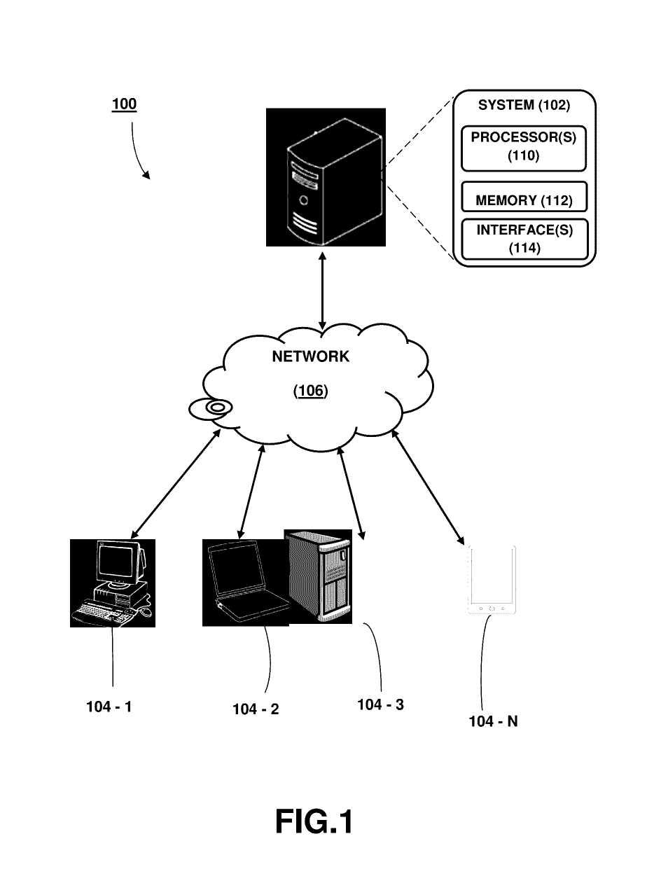

Referring now to FIG. 1, the system 102 for providing code coverage of a code is shown, in accordance with an embodiment of the present subject matter. Although the present subject matter is explained considering that the system 102 is implemented on a computer, it may be understood that the system 102 may also be implemented in a variety of computing systems including but not limited to, a smart phone, a tablet, a notepad, a personal digital assistant, a handheld device, a laptop computer, a notebook, a workstation, a mainframe computer, a server, and a network server. In one embodiment, the system 102 may be implemented in a cloud-based environment. It will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer with a webcam, a personal digital assistant with a camera, a handheld device with a camera, and a digital camera. The user device 104 is communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, as illustrated using the FIG. 1, the system 102 may include at least one processor 110, a memory 112, and input/output (I/O) interfaces 114. Further, the at least one processor 110 may be implemented as one or more microprocessors, microcomputers, microcontrollers, digital signal processors, central processing units, state machines, logic circuitries, and/or any devices that manipulate signals based on operational instructions. Among other capabilities, the at least one processor 110 is configured to fetch and execute computer-readable instructions stored in the memory 112.

The I/O interfaces 114 may include a variety of software and hardware interfaces, for example, a web interface, a graphical user interface, and the like. The I/O interfaces 114 may allow the system 102 to interact with a user directly. Further, the I/O interfaces 114 may enable the system 102 to communicate with other computing devices, such as web servers and external data servers (not shown). The I/O interfaces 114 can facilitate multiple communications within a wide variety of networks and protocol types, including wired networks, for example, LAN, cable, etc., and wireless networks, such as WLAN, cellular, or satellite.

The memory 112 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one embodiment, the system 102 may determine a type of file comprising a code. Further, the code may be uncompiled and may further be referred as uncompiled code. The system may process the uncompiled code in order to determine the type of file. The type of file, determined by the system, may comprise at least one of JavaScript, Hyper Text Markup Language (HTML) pages, CSHTML pages, internal user controls, partial views, master pages, Java Server Pages (JSP), Cascading Style Sheets (CSS), Active Server Page Extended (ASPX) file, ASCX file and Extensible Markup Language (XML) resources. In one case, usage of the above mentioned type of files in present scenario may be different from a conventional way of usage as in an application life cycle. For an example, a page may be posted back to a server and may subsequently be reloaded in case of a system request. Further, the page may be used as a child page or a parent page of a main page.

Subsequent to determining the type of file, the system may extract a source code from the uncompiled code. The source code may be present in at least an inline file, an embedded form, and an external dedicated file. In one case, the system may extract a JavaScript source code. However other types of source codes may be extracted by the system, further description is provided with reference to the JavaScript source code. The system may extract the JavaScript source code by using a parser on a JavaScript embedded in web pages or an external JavaScript file. In one case while the type of file comprises the HTML pages, the system may use a HTML parser to extract the JavaScript source code from the HTML pages. In another case when the type of file comprises the CSHTML pages or other web pages, the system may use a generic parser to extract the JavaScript source code from the CSHTML pages or the other web pages.

Post extraction of the JavaScript source code, the system may process the JavaScript source code to generate a structured JavaScript source code. In one case, the system may process a compressed or a minimized jQuery for generating the structured JavaScript source code.

Upon generating the structured JavaScript source code, the system may instrument the structured JavaScript source code file for adding test codes into functions of the source code. The functions may also be identified as program modules of the structured JavaScript source code. The test codes act as counters and increments a stored value whenever the functions are traversed upon execution of test cases. The test codes also counts a number of times each function get traversed by each of the test cases.

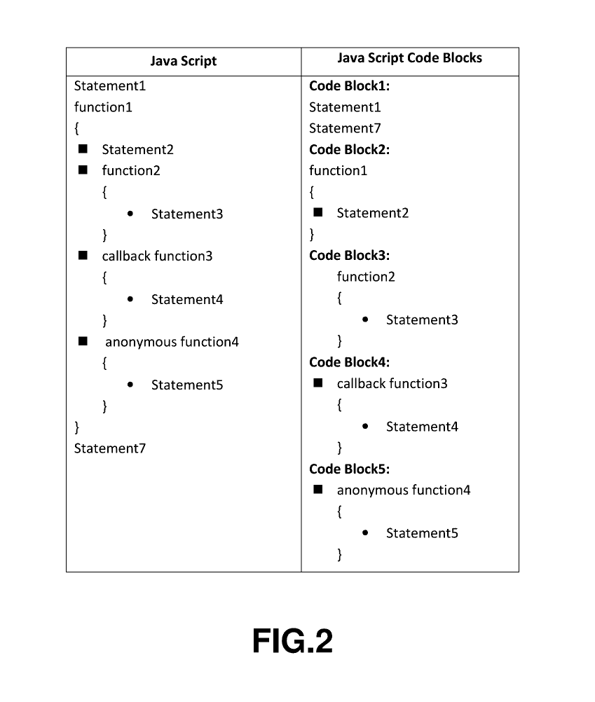

In one embodiment, the system may generate code blocks of the structured JavaScript source code. In one case, the system may generate the code blocks based on a type of declaration of statements, functions, and sub-functions present in the structured JavaScript source code. The code blocks may be indicative of a portion of the structured source code. Referring to FIG. 2, as an example, code blocks corresponding to a JavaScript code are illustrated. Statement 1 and statement 7 are globally declared and may comprise global variables, of the JavaScript code. Thus, the system classifies the statement 1 and the statement 7 into a code block 1. The JavaScript code includes a function 1 comprising a statement 1 and sub-functions i.e. a function 2, a callback function 3, and an anonymous function 4. The system identifies the function 1 and the sub-functions i.e. the function 2, the callback function 3, and the anonymous function 4 as code block 2, code block 3, code block 4, and code block 5 respectively. In one case, the system may set an environment before executing test cases and may clean the environment upon execution of the test cases, on the structured JavaScript source code.

In one embodiment, the system may determine intermediate code blocks coverage for browser based applications by analytical script addition to web pages. While injecting the analytical script on the web pages, the system may hook web browser Application Programming Interfaces (API's) from outside to dump information collected from global windows object into a local storage. However, different approaches may be used for different types of applications to dump coverage collection information in intermediate manner, separately for each test case.

In one embodiment, upon generating the structured JavaScript source code and the code blocks, the system may prepare a test environment to determine code coverage of the structured JavaScript source code. Post preparing the test environment, the system may execute test cases upon the structured JavaScript source code for determining the code coverage of the structured JavaScript source code. The system may execute the test case upon the structured JavaScript source code in a sequential manner. In one case, the system may store the code coverage of the structured JavaScript source code in form of an array. The system may further determine code block coverages of the code blocks by mapping the code coverage of the structured JavaScript source code with the code blocks. Thus, the system may identify program statements falling under the code blocks and a number of times the program statements are traversed. The system may count the number of times each program statement gets traversed by each of the test cases, by using the test codes, as mentioned earlier and may thus prepare a code coverage report.

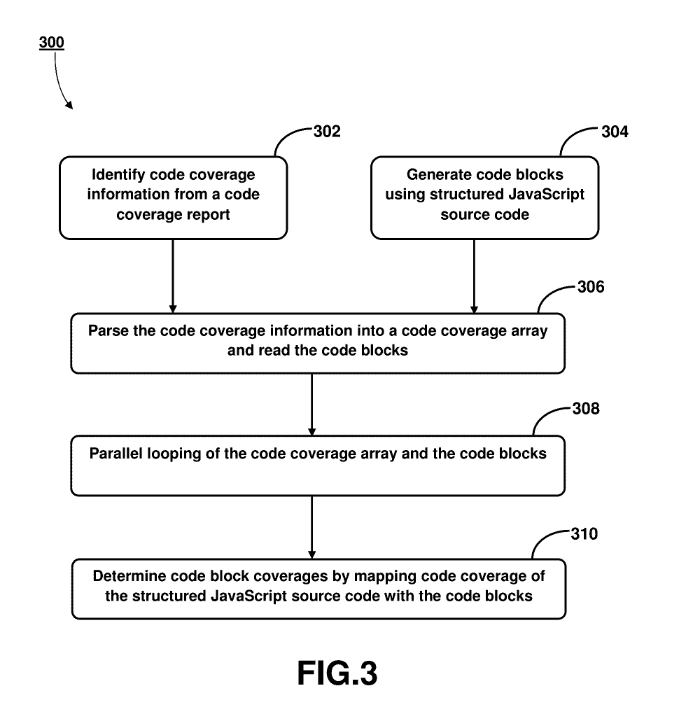

Referring to FIG. 3, a flowchart showing a method for determining code block coverages is illustrated. At step 302, the system may identify code coverage information form a code coverage report. Simultaneously, at step 304, the system may generate code blocks using the structured JavaScript source code. Subsequently, at step 306, the system may parse the code coverage information into a code coverage array and may read the code blocks. At step 308, the system may parallel loop the code coverage array and the code blocks. At step 310, the system may determine code block coverages by mapping the code coverage of the structured JavaScript source code with the code blocks.

Subsequently, the system may provide the code coverage report comprising line coverages, program coverages, and the code block coverages of the structured JavaScript source code. The line coverages indicate coverages of each program statement of the structured JavaScript source code. The program coverages indicate coverages of the functions and sub-functions of the structured JavaScript source code. The code block coverages refer to the coverage of the code blocks of the structured JavaScript source code. In one case, the system may store the code coverage report in the memory in an Extensible Markup Language (XML) format.

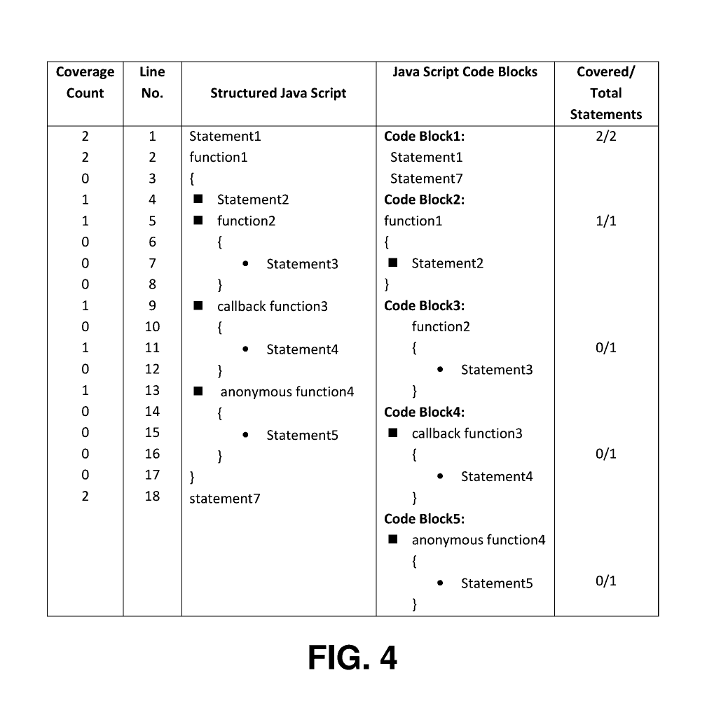

Referring to FIG. 4, an exemplary code coverage report of the code blocks corresponding to the JavaScript code is described. The FIG. 4 shows a number of program statements covered out of a total number of program statements corresponding to the code blocks. Regarding the code block 1, a number of program statements covered are 2 and the total number of program statements corresponding to the code block 1 are also 2. Thus, code coverage for the code block 1 is 2/2. Regarding the code block 3, the number of program statements covered is 0 and the total number of program statements corresponding to the code block 3 is 1. Thus, code coverage for the code block 3 is 0/1.

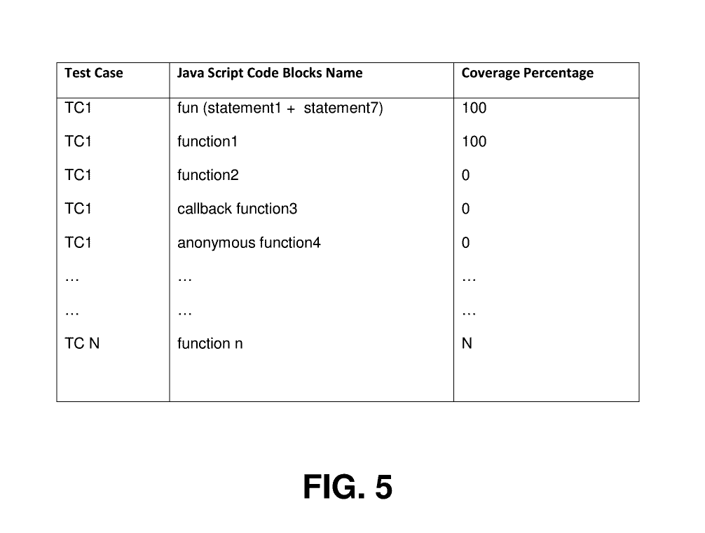

Referring to the FIG. 5, an exemplary code coverage report comprising coverage of functions by test cases is explained. The coverage of functions may also be referred as the program coverages. For an example, the code block 1 comprising the statement 1 and the statement 7 is shown to be covered by test case 1, and the coverage percentage is 100. Further, the function 1 is shown to be covered by the test case 1 and the coverage percentage is 100. In one case, the system may store the program coverages and the code blocks in the memory. Further, the program coverages and the code blocks may be stored in an incremental manner, for optimizing consumption of the memory.

In one embodiment, the system may use the code coverage reports to identify redundant test data. The system may identify unexecuted test cases, or test cases covering the code blocks for more than once, or code blocks remaining uncovered by certain test cases. The system may also use the code coverage reports for performing test impact analysis. The system may monitor increase and decrease in code coverage of the uncompiled code for performing the test impact analysis. Generally, the code blocks get modified in different versions of a code and may be referred as modified code blocks. The code blocks may get modified in Java Script, CSS, html, xml, and other web pages and is not limited to a particular language or technology. In one case, the system may perform the test impact analysis by mapping the test cases with the code blocks and the modified code blocks. In one case, the system may be used to determine the code coverage of a distributed web application deployed at a remote location by using a test agent exposing a service end point.

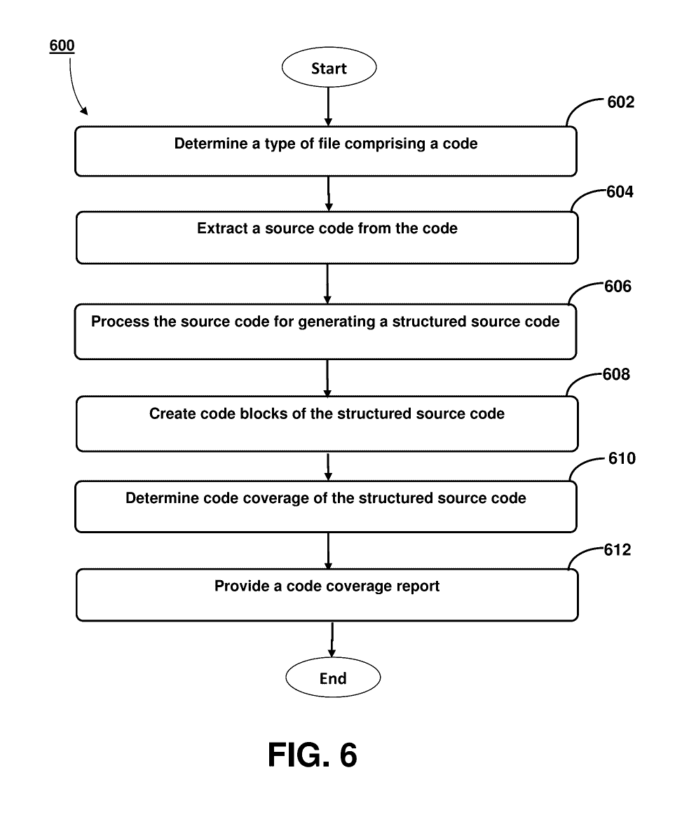

Referring now to FIG. 6, a method 600 for providing code coverage of a code is described, in accordance with an embodiment of the present subject matter. The method 500 may be described in the general context of computer executable instructions. Generally, computer executable instructions can include routines, programs, objects, components, data structures, procedures, modules, functions, etc., that perform particular functions or implement particular abstract data types. The method 500 may also be practiced in a distributed computing environment where functions are performed by remote processing devices that are linked through a communications network. In a distributed computing environment, computer executable instructions may be located in both local and remote computer storage media, including memory storage devices.

The order in which the method 600 is described is not intended to be construed as a limitation, and any number of the described method blocks can be combined in any order to implement the method 600 or alternate methods. Additionally, individual blocks may be deleted from the method 600 without departing from the spirit and scope of the subject matter described herein. Furthermore, the method can be implemented in any suitable hardware, software, firmware, or combination thereof. However, for ease of explanation, in the embodiments described below, the method 600 may be considered to be implemented in the above described system 102.

At block 602, a type of file comprising a code may be determined. In one implementation, the type of file may be determined by the processor 110.

At block 604, a source code may be extracted from the uncompiled code. The source code may be extracted based on the type of file. The source code may be extracted using a parser. In one implementation, the source code may be extracted by the processor 110.

At block 606, the source code may be processed for generating a structured source code. In one implementation, the source code may be processed for generating a structured source code by the processor 110.

At block 608, code blocks of the structured source code may be created. The code blocks may be created based on a type of declaration of statements, functions, and sub-functions. In one implementation, the code blocks may be created by the processor 110.

At block 610, code coverage of the structured source code may be determined by executing test cases upon the structured source code. In one implementation, the code coverage of the structured source code may be determined by the processor 110.

At block 612, a code coverage report may be provided. The code coverage report may comprise line coverages, program coverages, and code block coverages of the structured source code. In one implementation, the code coverage report may be provided by the processor 110.

Although implementations for methods and systems for providing code coverage of a code have been described in language specific to structural features and/or methods, it is to be understood that the appended claims are not necessarily limited to the specific features or methods described. Rather, the specific features and methods are disclosed as examples of implementations for providing code coverage of an uncompiled code.

Exemplary embodiments discussed above may provide certain advantages. Though not required to practice aspects of the disclosure, these advantages may include those provided by the following features.

Some embodiments may enable a system and a method to generate code blocks of a source code.

Some embodiments may enable a system and a method to determine code coverage of the source code in form of line coverages, program coverages, and code block coverages.

Some embodiments may enable a system and a method to identify redundant test data.

Some embodiments may enable a system and a method to process JavaScript source codes present in file embedded inline or present in separate external JavaScript files.

Some embodiments may enable a system and a method to identify a used or unused, dynamic or static embedded, inline or external CSS separately for each test case or page.

Some embodiments may enable a system and a method to execute manual and automated test cases upon the structured JavaScript source code.

Some embodiments may enable a system and a method that could be integrated to test management tools like test link and bugzilla.

Some embodiments may enable a system and a method to store incremental test cases for optimizing usage of the memory.

Some embodiments may enable a system and a method to generate the test coverage reports in xml, or emma xml, or a simple xml format which is easily understandable.

Some embodiments may enable a system and a method to determine the code coverage independent of a type of application, location and manner of hosting of the application. In case of a web based application, a client side scripting language instrumented code can be responded from a local system without hosting on an application server.

We claim:

1. A method for providing code coverage of a code, the method comprising:
determining, by a processor, a type of file comprising a code;
extracting, by the processor, a source code from the code based on the type of file, wherein the source code is extracted using a parser;
processing, by the processor, the source code for generating a structured source code;
creating, by the processor, code blocks indicative of a portion of the structured source code, based on a type of declaration of statements, functions, and sub-functions;
determining, by the processor, code coverage of the structured source code by executing test cases upon the structured source code; and
providing, by the processor, a code coverage report comprising line coverages, program coverages, and code block coverages of the structured source code.

2. The method of claim 1, wherein the type of file comprises at least one of JavaScript, HTML pages, CSHTML pages, internal user controls, partial views, master pages, Java Server Pages (JSP), Cascading Style Sheets (CSS), Active Server Page Extended (ASPX) file, ASCX file and Extensible Markup Language (XML) resources.

3. The method of claim 1, wherein the parser comprises at least one of a generic parser and a Hyper Text Markup Language (HTML) parser.

4. The method of claim 1, wherein the source code is present in at least an inline file, an embedded form, and an external dedicated file.

5. The method of claim 1, further comprising instrumenting the source code for adding test codes into the functions of the structured source code.

6. The method of claim 1, further comprising determining intermediate code block coverage for browser based applications by adding analytical script to web pages.

7. The method of claim 1, further comprising determining code block coverages of the code blocks by mapping the code coverage of program lines with the code blocks.

8. The method of claim 1, further comprising identifying redundant test data by using the code coverage report.

9. The method of claim 1, further comprising performing test impact analysis by mapping the test cases with the code blocks and modified code blocks of the code.

10. The method of claim 1, further comprising storing program coverages and the code blocks and the code coverage in an incremental manner.

11. The method of claim 1, further comprising determining the code coverage of a distributed web application deployed at a remote location by using a test agent exposing a service end point.

12. A system for providing code coverage of a code, the system comprises:
a processor; and
a memory coupled to the processor, wherein the processor is capable for executing programmed instructions stored in the memory to:
determine a type of file comprising a code;
extract a source code from the code based on the type of file, wherein the source code is extracted using a parser;
process the JavaScript source code for generating a structured source code;
create code blocks indicative of a portion of the structured source code, based on a type of declaration of statements, functions, and sub-functions;
determine code coverage of the source code by executing test cases upon the structured source code; and
provide a code coverage report comprising line coverages, program coverages, and code block coverages of the structured source code.

13. The system of claim 12, wherein the type of file comprises at least one of JavaScript, HTML pages, CSHTML pages, internal user controls, partial views, master pages, Java Server Pages (JSP), Cascading Style Sheets (CSS), Active Server Page Extended (ASPX) file, ASCX file and Extensible Markup Language (XML) resources.

14. The system of claim 12, wherein the parser comprises at least one of a generic parser and a Hyper Text Markup Language (HTML) parser.

15. The system of claim 12, wherein the source code is present in at least an inline file, an embedded form, and an external dedicated file.

16. The system of claim 12, further comprising instrumenting the JavaScript for adding test codes into functions of the structured source code.

17. The system of claim 12, further comprising determining intermediate code block coverage for browser based applications by adding analytical script to web pages.

18. The system of claim 12, further comprising determining code block coverages of the code blocks by mapping the code coverage of program lines with the code blocks.

19. The system of claim 12, further comprising identifying redundant test data by using the code coverage report.

20. The system of claim 12, further comprising performing test impact analysis by mapping the test cases with the code blocks and modified code blocks of the code.

21. The system of claim 12, further comprising storing program coverages and the code blocks and the code coverage in an incremental manner.

22. The system of claim 12, further comprising determining the code coverage of a distributed web application deployed at a remote location by using a test agent exposing a service end point.

23. A non-transitory computer readable medium embodying a program executable in a computing device for providing code coverage of a code, the program comprising:
a program code for determining a type of file comprising a code;
a program code for extracting a source code from the code based on the type of file, wherein the source code is extracted using a parser;
a program code for processing the source code for generating a structured source code;
a program code for creating code blocks indicative of a portion of the structured source code based on a declaration of statements, functions, and sub-functions;
a program code for determining code coverage of the structured source code by executing test cases upon the structured source code; and
a program code for providing a code coverage report comprising line coverages, program coverages, and code block coverages of the structured source code.
